(19) United States
(12) Patent Application Publication
(10) Pub. No.: US 2010/0333194 A1
(43) Pub. Date: Dec. 30, 2010

(54) System, Method, and Apparatus for Capturing, Securing, Sharing, Retrieving, and Searching Data

(76) Inventors: Camillo Ricordi, Miami, FL (US); Steven Sikes, Miami, FL (US); Stephen William Anthony Sanders, Sebastopol, CA (US); Nicholas Fotios Tsinoremas, Miami, FL (US)

Correspondence Address: LOEB & LOEB, LLP, 321 NORTH CLARK, SUITE 2300, CHICAGO, IL, 60654-4746, US

(21) Appl. No.: 12/495,177

(22) Filed: Jun. 30, 2009

(51) Int. Cl. G06F 17/30; G06F 21/00

(52) U.S. Cl. 726/17; 707/759; 707/769; 707/912; 707/955; 707/957

(57) ABSTRACT

This present invention relates to a system, method and apparatus for scientists and researchers and others to capture, secure, share, retrieve and search captured data. Said system and method is able to: fully-integrate hardware and software, required to seamlessly capture data inputs; combine edit and display functions from devices into one single edit and display platform; compile captured inputs from devices into text-searchable and tag-able data that can be displayed, edited and searched on one platform; compile captured inputs from devices into text-searchable and tag-able data that can be searchable by using free-text search, advanced search modules, or a combination thereof; provide advanced search modules that can search based on embedded text in files, tags tied to images or files, parallel image search and other intelligent parameter-based search formats; and can be provided as a hosted application, available via a wire line or wireless on-demand service, also referred to as Software as a Service (SaaS) delivery method.

### FIELD OF THE INVENTION

This present invention is in the field of providing a system, method and apparatus for scientists and researchers and others to capture, secure, share, retrieve and search captured data. Said invention shall allow end users to perform the above-mentioned functions on one fully-integrated edit and display platform, in which captured data is made fully-text searchable, can be tagged, edited, and searched using advanced search modules, and can be offered over a wire line or wireless network as a service. The capture of data is integrated onto one platform that supports several devices. The retrieval and search for captured data can be in multiple formats, in which end users may locate data in several different formats. End users can make annotations to captured data, as well as search for data based on keywords, visual and audio queries, parallel image search and fully-integrated text-based, semantic queries.

### BACKGROUND OF THE INVENTION

There exists a variety of electronic systems for collecting, storing and authenticating data. These systems include the electronic lab notebooks (ELN) that are used primarily by companies in the life sciences sector. Often these systems are content-specific, i.e., they focus on certain fields such as chemistry, biology, and genetics, and the systems are customized and integrated within the companies' informatics and R&D departments.

As an alternative to paper-based documentation, many organizations and firms are utilizing electronic lab notebooks to improve record-keeping, to verify contributions by individuals, and to serve as evidence in any future patent or legal dispute. Moreover, many companies in the life sciences sector have been turning to Laboratory Information Management Systems (LlMS) for aggregating and managing lab data. These systems aim to integrate and manage data in specific areas on a large scale, or based on specific project requirements, but they do not fully address the needs of researchers, investigators or scientists working on projects requiring multiple data entries from several sources or devices, nor do they provide the most optimum platform for said parties to document and secure novel ideas and confidential information.

Academic institutes have been slow to adopt digital and electronic lab notebooks, primarily because of the costs involved in customization and integration, however, the costs to implement paperless research have dropped considerably, especially due to advances in mobile technology, reduced time cycles to develop applications, increased compatibility across platforms, and technological advances for enhancing data security through encryption and authentication tools.

Intellectual property assets and patentable ideas are the building blocks for facilitating novel discoveries, scientific advances and accelerated cures. Ideas often need to be documented and legally protected before they can be shared. Filing a single patent can consume months of a researcher's time, whereas digital notebooks and mobile data capturing tools can help streamline the filing of patents by using templates and modules to store, aggregate and organize data and information. The real value of a digital system lies in securing confidential information in a personalized environment. From a legal perspective, the ability to identify the creators and originators of ideas, and the concomitant dates, locations, and information involved in the discovery process is relevant for establishing intellectual property protection and ownership rights. Moreover, a mobile computing device provides more opportunities for point-of-discovery data capture, especially while collecting new ideas and thoughts during lab protocols, field research, and clinical trials, since it can be taken with the end user as opposed to a fixed device, PC or work station.

Scientists and researchers lose valuable time trying to locate ideas, information and data; they often misplace content and often have difficulties deciphering hastily scribbled notes and jottings. Developers are utilizing emerging and maturing Web 2.0 and Mobile 2.0 tools to create user-friendly applications that are enabling scientists and researchers to capture and share information from web-based and mobile platforms. As the content creators and idea originator, these researchers, scientists, and investigators can influence the parameters for potential integration and collaboration.

Research institutes need to protect confidential information and data with greater security and advanced authentication tools. If unauthorized users gain access to key data, they can disrupt the discovery process, corrupt or delete information, or utilize the content for unethical or self-serving purposes.

In current research environments, there can be “information overload,” where large amounts of data needs to be edited, consolidated, categorized, tagged and organized. Paper-based documentation often does not satisfy the commercial and scientific needs of organizations and many organizations and research institutes have resorted to outsourcing or developing digital or electronic platforms and applications to capture, secure, share, retrieve and search content, thoughts and ideas.

Digital platforms support a wide range of information protocols. Such platforms and applications accelerate the dissemination of information to relevant parties, including colleagues, supervisors, legal experts, notaries, partners, and informatics and administration personnel. Moreover, the automated registering of content and metadata, time-stamping data, and delineating audit channels reduce potential conflicts and disputes, while increasing workflow and productivity.

Advanced technologies enable researchers to capture information and data via multiple inputs on PCs, tablet PCs, mobile devices and other devices, including images, audio and video recordings, scanned files, and documentation entries. These technologies enhance me real-time capture and dynamic protection of intellectual property assets and facilitate viable paths to commercializing these assets through grants, product development, licensing and other potential revenue-generating streams.

The mobile communication device is the indispensable tool for the 21^{st} century. It has supplanted the PC as the premier communication instrument worldwide. More people are accessing the web via mobile phones and they are utilizing embedded and integrated functionalities, including GPS tracking, multimedia, gaming, banking, social networking, location-based services, telemonitoring, and medical record-keeping. The mobile generation will continue to embrace applications which will enhance productivity, streamline activities, increase security and mitigate risk.

Today, researchers and scientists seek to convert their findings and work efforts into organized modules, managed results, detailed research publications and prospective intellectual property.

The suppliers of electronic laboratory notebooks are finding it increasingly difficult to be all-encompassing, necessitating more partnerships and off-the-shelf product assimilations. Increasing demands to bridge information silos across research departments exists and it is essential to lower barriers between internal research departments and outside collaborators.

Heretofore, inventors have not created and developed a system and method that is effective at capturing, securing, sharing, retrieving and searching data from multiple devices, and displaying, editing and making said data fully-text-searchable on one single platform that can be delivered over a wire line or wireless network, as a service. This can be accomplished as a Software as a Service (SaaS) method, which is a model of software deployment whereby a provider licenses an application to customers for use as a service on demand.

Accordingly, there still exists a need for a method, system, and apparatus for capturing, securing, sharing, retrieving and searching data but there does not appear to be an invention that possesses all of the features and components of our system and method. To summarize, the desired method, system, and apparatus should be able to be:
Fully-integrated with the requisite hardware and software required to seamlessly capture the end user's data inputs.
Combine edit and display functions from several devices into one edit and display platform for the end user.
Compile captured inputs from several devices into text-searchable and tag-able data that can be displayed, edited and searched on one platform for the end user.
Compile captured inputs from several devices into text-searchable and tag-able data that can be searchable by using free-text search, advanced search modules, or a combination thereof.
Provide advanced search modules that can search based on embedded text in file, tags tied to images or files, parallel image search or other intelligent search formats.
Provided as a hosted application that is available to the end user via a wire line or wireless networks as an on-demand service, also referred to as Software as a Service (SaaS).

### SUMMARY OF THE INVENTION

The present invention provides a method and application for capturing, securing, sharing, retrieving and searching said captured data. Said method and application enables the end user to perform the aforementioned functions while remaining on one platform or screen, which enables the end user to employ the use of integrated hardware and software in order to complete research. Therefore, the present invention allows the end user to thereby replace the use of computerized research systems that are not integrated onto one platform or screen, or the use of paper-based, traditional laboratory notebooks.

The present invention also relates to a method for capturing, securing sharing, retrieving and searching data comprising providing a software module comprising a graphical user interface for displaying captured data objects on a display, an input device module operably connected to one or more input devices to capture data objects, and code or modules for tagging captured data objects; receiving data objects from the one or more input devices; capturing the data objects; tagging the captured data objects; storing the captured data objects on a database; and wherein the software module, the editor and display module, the database and the search module are all operably connected. The software module may also comprise code, or modules, for registering one or more end users and creating end user profiles.

The invention also relates to a system for capturing and sharing data objects comprising a software module comprising a graphical user interface for displaying captured data objection a display; an input device module operably connected to one or more input devices to capture data objects, code, or modules, for tagging captured data objects, an editor and display module for allowing editing and display of captured data objects on the graphical user interface; a database for storing captured data objects; and a search module for allowing end users to search and retrieve captured data objects; wherein the software module, the editor and display module, the database and the search module are all operably connected. The system may also include code, or modules, for allowing registration of one or more end users and creation of one or more end user profiles;

The invention also relates to an apparatus comprising a client device comprising a software module allowing the input and capture of data objects by an end user; a search module for allowing an end user to search captured data objects; a tagging code or module, and an editor and display module for allowing an end user to review and edit captured data objects. The client device is operably connected to a database for storing captured data objects.

Related to data capture, said system and method allows the user to focus on their respective research and to focus on data input capture without deeply changing their existing behavior. The present invention does not require the user to be highly computer literate, since the workflow aspects of the present invention are integrated onto one platform or screen. Data that is captured by the user is displayed in an editable, searchable, “what you see is what you get” (WYSIWYG) format. Whether the captured data is text, audio, video, an image or other digital format, it will be both tagged and made fully-text searchable by the present invention.

Related to securing data, said system and method allows the user to logon to one platform in order to define their respective;access parameters as well as access parameters to view, edit and copy any captured data. User identification codes, passwords and CAPTCHA™ modules, which are a type of challenge-response test used in computing to ensure that the response is not generated by a computer, can be used for security purposes. The CAPTCHA™ module and process usually involves one computer (a server) asking a user to complete a simple test which the computer is able to generate and grade. Because other computers are unable to solve the CAPTCHA™, any user entering a correct solution is presumed to be human. These methods will be employed in order to assure that users are properly authenticated and given the proper access to said data. The present invention will secure all data inputs by users by saving them to a secure server and by storing said data on a redundant backup server so that user data can be stored outside of the user's respective device and thereby offered to the user via wire or wireless connectivity in the case the user desires to use said system and method as a hosted service, or Software as a Service (SaaS) method.

Related to sharing data, said system and method allows the user to logon to one platform in order to define their respective roles, including but not limited to administrator, principal investigator, investigator, team member, or other role. The present invention will allow any users to share or receive access to data based upon the access permissions that are associated with said role. The present invention will allow users to assure that their respective data is not shared improperly, such as outside of a properly-defined research team.

Related to data retrieval, said system and method allows the user to retrieve data without having to be highly computer literate, since the workflow aspects of the present invention are integrated onto one platform or screen. Data that is captured and able to be accessed by the user is able to be retrieved and subsequently displayed in an editable, searchable, “what you see is what you get” (WYSIWYG) format. Because the captured data, whether it is text, audio, video, an image or other digital format, can be both tagged and made fully-text searchable by the present invention, the ability to retrieve data is augmented. Said user can retrieve data in the form of notebook pages that can be organized in several formats, including but not limited to: chronological format; data captured per project, per user, per experiment, per location, per geographical area, per data tag or per text search. Said ability to retrieve data allows the user to quickly search for a specific data entry across large amounts of accessible data. This is especially helpful when projects may involve complexity or large amounts of data. Moreover, since the present invention allows the user to rapidly retrieve accessible data, and can display it on one edit and display platform that is fully-integrated into the hardware and software required to seamlessly capture and edit data inputs; it allows the user to rapidly start, stop and edit work; thereby creating a far-superior workflow than existing art.

Related to data search, said system and method allows the user to search data without having to be highly computer literate, since the workflow aspects of the present invention are integrated onto one platform or screen. Data that is captured and able to be accessed by the user is able to be searched and subsequently displayed in an editable, searchable, “what you see is what you get” (WYSIWYG) format. Because the captured data, whether it is text, audio, video, an image or other digital format, can be both tagged and made fully-text searchable by the present invention, the ability to search data is augmented. Said user can search data in the form of: a free-text search; an advanced search;, or a combination thereof. A free-text search will find data inputs based on a text query which will search across all text and tags either embedded in, or associated with captured data. An advanced search will allow the user to search across one or more parameters that are supported by the present invention, including but hot limited to text, role, time, date, place, phrase, project, experiment, organization, color, texture, taste, smell, motion, parallel image, semantic likeness, or a combination thereof. Moreover, said advanced search may be purely logic-based upon matching queries and non-matching queries or may be algorithm-based upon defining a either a weight or importance to one or more selected search parameters. Said ability to search data allows the user to quickly search for a-specific data entry across large amounts of accessible data. This is especially helpful when projects may involve complexity or large amounts of data. Moreover, since the present invention allows the user to rapidly search accessible data, and can display it on one edit and display platform that is fully-integrated into the hardware and software required to seamlessly capture and edit data inputs; it allows the user to rapidly start, stop and edit work; thereby creating a far-superior workflow than existing art.

The present invention utilizes a plurality of tools and components. Said tools include hardware, including but not limited to PCs, tablet computers, personal digital assistants (PDAs), digital pens, mobile communication devices, scanners, audio and video recorders, digital cameras, eye modules to fasten onto image capture tools, microscope eyepieces, lenses for image capture and other hardware.

The present invention also comprises an open source software platform, as well as visualization tools, such as a flexible display, which can be customized, configured, personalized and integrated to function seamlessly with said hardware.

Other systems, methods, features, and advantages of the present invention will be or will become apparent to one with skill in the art upon examination of the following figures and detailed description. It is intended that all such additional systems, methods, features, and advantages be included within this description, be within the scope of the invention, and be protected by the accompanying claims.

### BRIEF DESCRIPTION OF THE DRAWINGS

The accompanying drawings, which are incorporated in and constitute a part of this specification, illustrate an implementation of the present invention and, together with the description, serve to explain the advantages and principles of the invention. In the drawings:

FIG. 1 depicts an illustration of the system and method of the invention.

FIG. 2 depicts an illustration of a capture, secure and sharing process.

FIG. 3 depicts an illustration of a retrieval process.

FIG. 4 depicts an illustration of a search process.

FIG. 5 depicts an illustration of the system and method integration.

FIGS. 6A-6F depict illustrations of advanced search processes.

FIG. 7 depicts an illustration of the system of the invention,

FIG. 8 depicts an illustration of the apparatus of the invention.

FIG. 9 depicts an illustration of a screen shot of the editor and display module of the invention.

FIG. 10 depicts an illustration of an image from a digital camera and notes from a digital pen.

FIG. 11 depicts an illustration of the end user registration process.

### DETAILED DESCRIPTION OF THE INVENTION

The present invention relates to a system and application to facilitate capturing, securing, searching and retrieving data, especially as a way to preserve original ideas, confidential information, notes, and creations in a digital format, as opposed to paper-based documentation such as notebooks, lab books, diaries, and journals, which are vulnerable to errors and misinterpretations. Moreover, digitally captured data objects offer several advantages over paper-based entries: the ability to establish a poof of time at the point of capture and a spatial component, through geo-tagging and geo-referencing, if the capturing tool is GPS-enabled. The invention may be used in many situations including, but not limited to, lab experiments, medical procedures, scanning, backing up existing collected data, a visual or aural report of an event of episode, creative writing, of the keeping of a personal or professional journal.

Said system and method allows the user to focus on data input capture without deeply changing their existing behavior. The present invention allows the user to capture data from integrated devices in various formats and combinations thereof such as a combination of audio and video capture, or hand-written notes using a digital pen. The data captured by the user is displayed in an editable, searchable, “what you see is what you get” (WYSIWYG) format that also can display data captured in a chronologic format. Whether the captured data is text, audio, video, an image or other digital format, it will be both tagged and made fully-text searchable by the present invention. The present invention includes data capture in which voice is recorded and then transcribed to text that is searchable.

After data is captured by an integrated hardware device, the software application provides a method and interface for identifying and tagging the data objects. In one embodiment, the software, application enables the annotation of data objects by the users, and it enables the users to establish proprietary rights for their original works and ideas via digital signatures; moreover, it offers the possibility of time stamping by third party providers. In addition, the software application facilitates the management of digital rights for pages and forms and the dynamic generation of fields based on said forms and pages

The present invention also relates to a method for capturing, securing sharing, retrieving and searching data comprising providing a software module comprising a graphical user interface for displaying captured data objects on a display, an input device module operably connected to one, two or more input devices to capture data objects, code, or module, for tagging captured data objects; receiving data objects from the one, two or more input devices; capturing the data objects; tagging the captured data objects; storing the captured data objects on a database; and wherein the software module, the editor and display module, the database and the search module are all operably connected. The end user(s) may be registered via end user registration code or modules, and may also create end user profiles.

The invention also relates to a system for capturing and sharing data objects comprising a software module comprising a graphical user interface for displaying captured data objects on a display, an input device module operably connected to one, two, or more input devices to capture data objects, and code or modules for tagging captured data objects, an editor and display module for allowing editing and display of captured data objects on the graphical user interface; a database for storing captured data objects; and a search module for allowing end users to search and retrieve captured data objects; wherein the software module, the editor and display module, the database and the search module are all operably connected. The system can further comprise a memory storage module operably connected to the software module, the editor and display module, and the database for temporary storage of captured data. In addition, the system can also comprise code, or modules, for allowing registration of one or more end users and creation of one or more end user profiles.

The input devices that can be used to input data objects for capture, sharing and editing by one or more end users can be, but is not limited to a personal digital assistant (PDA), a mobile communications device, a scanner, an audio recorder, a video recorder, an eye module, a microscope eyepiece, a lens for image capture, a digital pen, or a digital camera. These devices can input the data objects as written text, digital images, audio, video, digital files, and a combination thereof. Once captured, the data objects can be tagged, either automatically or directly by the end user. Then, one or more other end users can search and retrieve the data objects from the memory storage module or the database in a form selected from the group consisting of written text, digital images, audio, video, digital files, and a combination thereof. The search can be performed using a tool that can be, but is not limited to geo-location, semantic, personal search, behavioral search, and multi-sensory queries, and a combination thereof. The multi-sensory queries can be of visual, aural, tactile, or smell queries

The system of the invention allows one or more end users to share the captured data objects. In addition, the one or more end users can edit the data objects by annotations, revisions, comments, reviews, and feedback pertaining to the captured data. The data objects may be viewed by the one or more end users as indexing via text, images as thumbnails, a slideshow format, audio clips, and video clips.

The invention also relates to an apparatus comprising a client device comprising a software module allowing the input and capture of data objects by an end user, a search module for allowing an end user to search captured data objects, and an editor and display module for allowing an end user to review and edit captured data objects. These, components are operably connected to one or more databases for storing captured data objects operably connected to the client device.

The apparatus may also comprise one or more input devices selected from the group consisting of a personal digital assistant (PDA), a mobile communications device, a scanner, an audio recorder, a video recorder, an eye-piece holder, a microscope eyepiece, a lens for image capture, a digital pen, a digital camera and a combination thereof. In addition, the apparatus can also include a memory storage module operably connected to the software module, the editor and display module, the storage module, and the database.

The software module of the apparatus may also comprise code for tagging the captured data objects. The tagging of captured data objects can be performed automatically or directly by the end user.

The apparatus of the invention can also be such that one or more other end users is able to search, display, and edit the captured data objects. The one or more end users can register via user registration code, whereby access to the system is given so that the one or more end users can search, display, and edit the captured data objects. The captured data objects can be viewed via a graphical user interface.

In one embodiment of the present invention, a handheld device or mobile communication device comprising a plurality of digital tools, collects said data; hereinafter, the software identifies the data objects based oh characteristics, including but not,limited to the type of file, its location upon point-of-capture, the parameters set by default or pre-set by the user, the classification of data object entries based on, including but to limited to, features, priority, personalization, preference, most viewed (i.e., popular), most recently captured, or a combination thereof.

In another embodiment, the application automatically tags the location of the data objects at the point of capture utilizing GPS technology and it enables the user to verify their identity with a personalized interface that provides a functionality to enter digital signatures or voice prints. A verification functionality for confirming the user through biometrics such as facial recognition, voice print, iris or fingerprint scan can be employed in order to protect data or to authenticate a user. Third party providers can be used to support authentication and time-stamping. Since the present invention can be provided as a hosted application, available via a wire line or wireless on-demand service, also referred to as Software as a Service (SaaS) delivery method, various securing protocols may be integrated to support the present invention.

The preferred embodiment of the present invention will now be described in even greater detail by reference to the following figures.

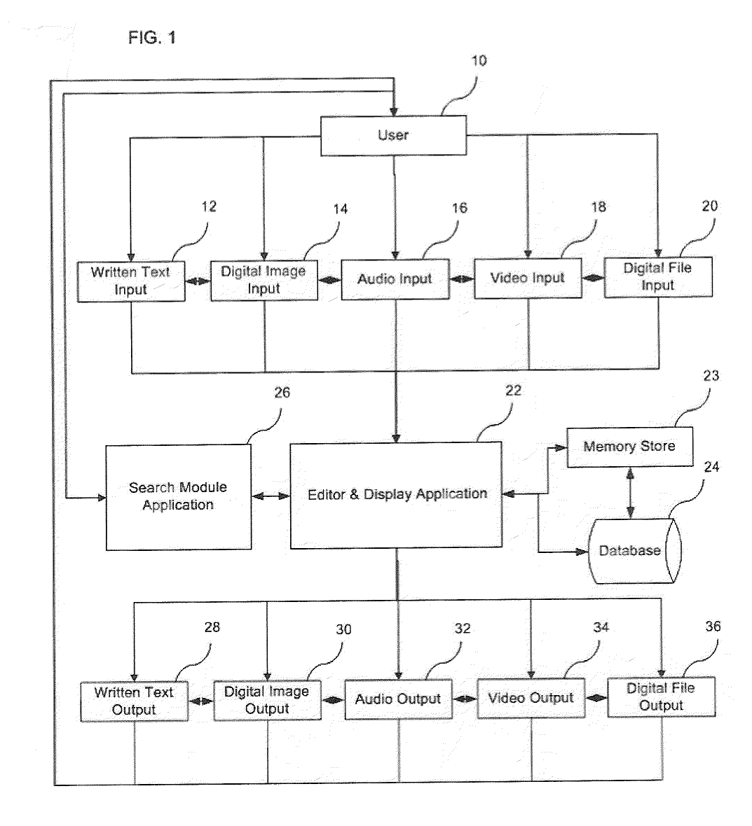

FIG. 1 depicts a general overview of said system and method in which an end user 10 is able to create various types of inputs. Said inputs may be written text input 12, digital image input 14, audio input 16, video input 18; digital file input 20 or a combination thereof. An editor and delay application 22 will facilitate the ability of said end user 10 to capture said various inputs, as well as retrieve and search the captured data. The editor and display application 22 is operably connected to a system database 24 and, optionally, to a memory store 23, as well as to a search module application 26. The end user 10 is able to use said editor and display application 22 to export data or to create various outputs, which may be in the forms of written text output 28, digital image output 30, audio output 32, video output 34, digital file output 36, or a combination thereof. The end user 10 can then collect various types or input, use the search module application 26 for searching captured data, and export various types of the output, all from one integrated platform, which is supported by the editor and display application 22. The memory store 23 provides a secondary and/or temporary location for the storage of captured data and related information.

Furthermore, the registered end user(s) can access the system by inputting information in order to verify, authenticate, and/or identify that end user. In one embodiment, the end user registers and creates an end user profile. This comprises information that can be used for confirming, authenticating or verifying the identity of the end user. This information can be,.but is not limited to password encryption, digital signatures, biometrics, CAPTCHA™ (challenge-response test) modules, answers to pre-selected questions, geo-referencing, and voice prints for verifying, confirming or authenticating end users. Further, one or more other end users may register in order to be able to capture, share, and/or edit the data objects. As above, these end users may be confirmed, authenticated and/or verified by the same methods, as found in the other end users' profiles.

The data input device may be selected from the group consisting of a personal digital assistant (PDA), a mobile communications device, a scanner, an audio recorder, a video recorder,.an eye module, a microscope eyepiece, a lens for image capture, a digital pen, and a digital camera, or combinations thereof. Because of the wide variety of input devices that can be used with the invention, the data objects can be in the form of written text, digital images, audio, video, digital files, or a combination thereof. The data objects can be input and captured during the course of may types of events; For example, the data objects, can be input and captured during laboratory experiments, when taking patient histories, performing medical procedures, during brainstorming sessions, during group meetings, or keeping a personal or professional journal. After input and capture, the data objects can be tagged. The tagging process can be automatic or the end user can assign tags to the captured data objects. Tagging can identify the captured data objects by means including, but not limited to, text, micro-blogging, voice, geo-referencing, of keywords, or a combination thereof. The captured data objects can be stored directly in the database, or temporarily in an additional memory storage module, before being stored in the database.

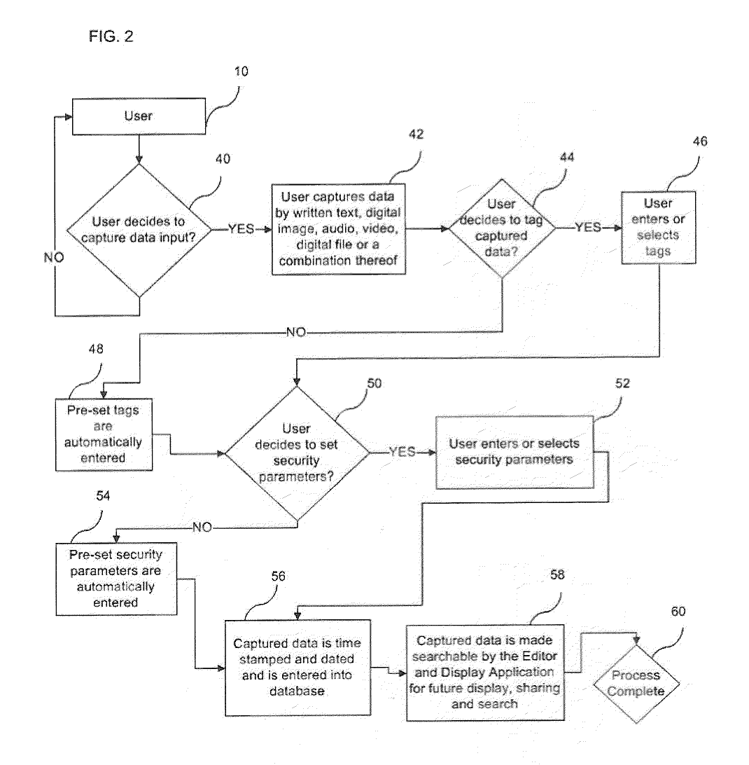

FIG. 2 depicts, a general overview of a capture, secure and sharing process in which said end user 10 may decide to capture data input 40. Said end user may capture data via written text, digital image, audio, video, digital file, or a combination thereof 42, after which said end user may decide to tag captured data 44. If said end user decides to tag captured data 44, then said end user enters or selects tags 46. If said end user decides not to tag captured data 44, then pre-set tags are automatically entered 48. After which, if end user decides to set security parameters 50 then captured data is time stamped and,dated and is entered into a database 56. If end user decides not to set security parameters 50 then pre-set security parameters are automatically entered 54, after which captured data is time stamped and dated and is entered into a database 56. After captured data is time stamped and dated and is entered into a database 56, then captured data is made searchable by the editor and display application for future display, sharing and search 58, after which said process is complete 60.

Individuals, particularly scientists and researchers, lose a large percentage of paper-based data documentation. In addition, they spend valuable time and resources trying to retrieve data that is not stored in a digital format. By tagging data entries after digital capture, and subsequently transferring these data objects to files for storage, they will be able to access and retrieve these data objects after logging in and entering the respective key words and metadata in a search query. Tagging can use personal information, characteristics, spatial and temporal keyword and tags, a plurality of extracted visual or aural objects which could include but not be limited to colors, shapes, tones, textures, and/or geo-location to identify data objects.

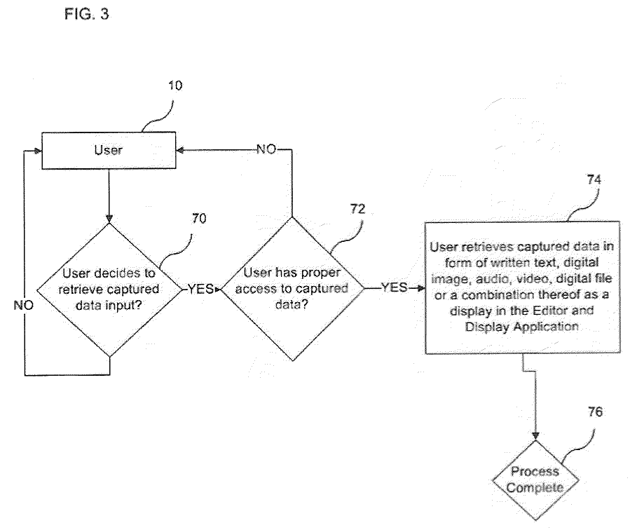

FIG. 3 depicts a general overview of a retrieval process in which said end user 10 decides to receive captured data input 70, and if affirmative then said system will determine if said end user has proper access to captured data 72. If said end user does indeed have proper access to captured data 72, then end user receives captured data in forms of written, text, digital image, audio, video, digital file or a combination thereof as a display in the editor and display application 74, after which said process is complete 76.

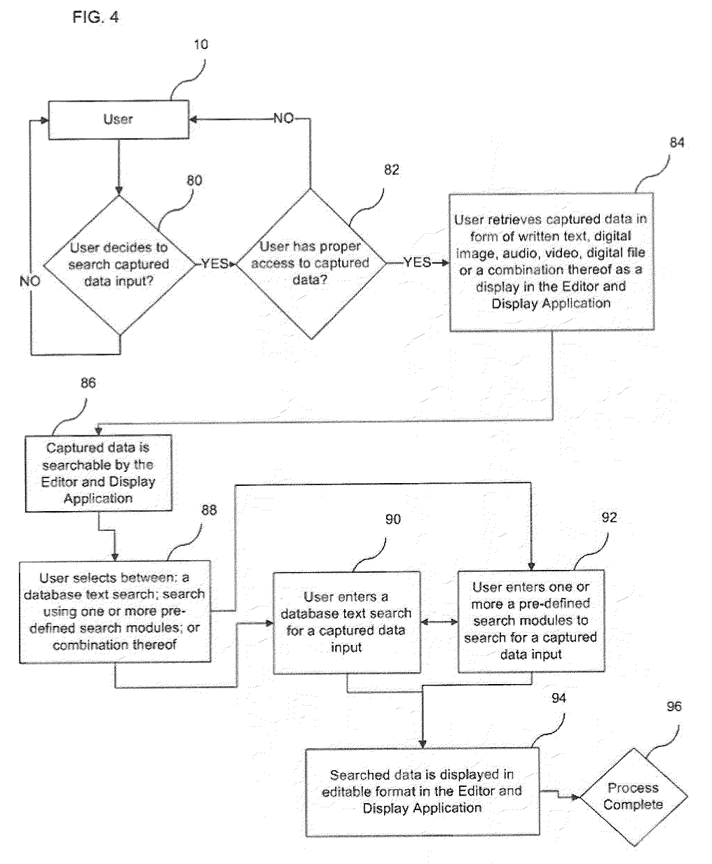

FIG. 4 depicts a general overview of a search process in which said end user 10 decides to search captured data input 80, and if affirmative then said system will determine if said end user has proper access to captured data 82. If said end user does indeed have proper access to captured data 82, then end user receives captured data in forms of written, text, digital image, audio, video, digital file or a combination thereof as a display in the editor and display application 84, after which said captured data is searchable by the editor and display application 86. Then, end user selects between: a database text search; search using one or more pre-defined search modules; or combination thereof 88. Then, said end user will either enter a database text search for a captured data input 90, enter one or more pre-defined search modules to search for a captured data input 92, or a combination of both previously mentioned steps. After which said searched data is displayed in editable format in the editor and display application 94, thereby completing;said process 96.

Once the data objects are captured and tagged, the one or more end users can search and retrieve the information from the memory story and/or database. The data objects can be retrieved in the form of written text, digital images, audio, video, digital files, or a combination thereof. Further, the search and retrieval can be performed using a tool selected from the group consisting of geo-location, semantic, personal search, behavioral search, and multi-sensory queries, or a combination thereof. The multi-sensory queries may be visual, aural, tactile, or smell queries.

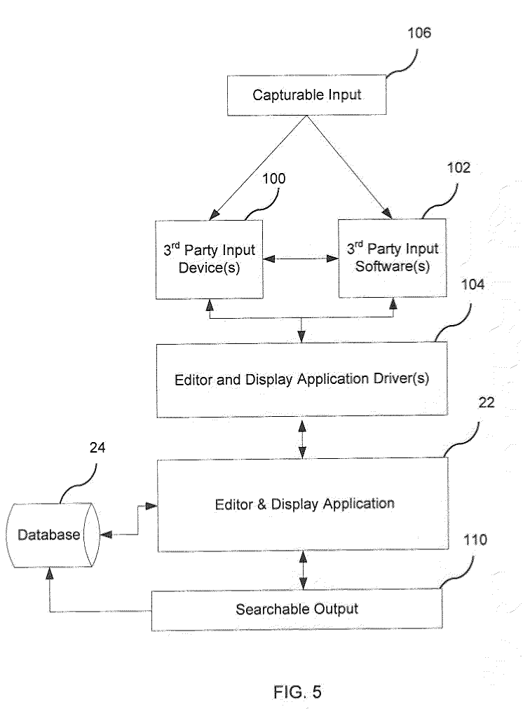

FIG. 5 depicts a general overview of said system and method integration in which either one, two or more third party input devices 100, one, two or more third party input software 102, or a combination thereof communicates and interoperate with one or more editor and display application display drivers 104. The one or more editor and display application display drivers 104, are employed to gather capturable input 106 from the third party input devices, which is displayed in the editor and display application 22 and also archived in a database 24. The editor and display application 22 allows for the creation of input into fully-text searchable data, which serves as searchable output 110.

The one or more end users can edit the captured data objects. Tools that can be used to edit the data objects can be, but are not limited to, annotations, revisions, comments, reviews, and feedback pertaining to the captured data. The data objects can be viewed as indexing via text, images as thumbnails, a slideshow format, audio clips, and video clips.

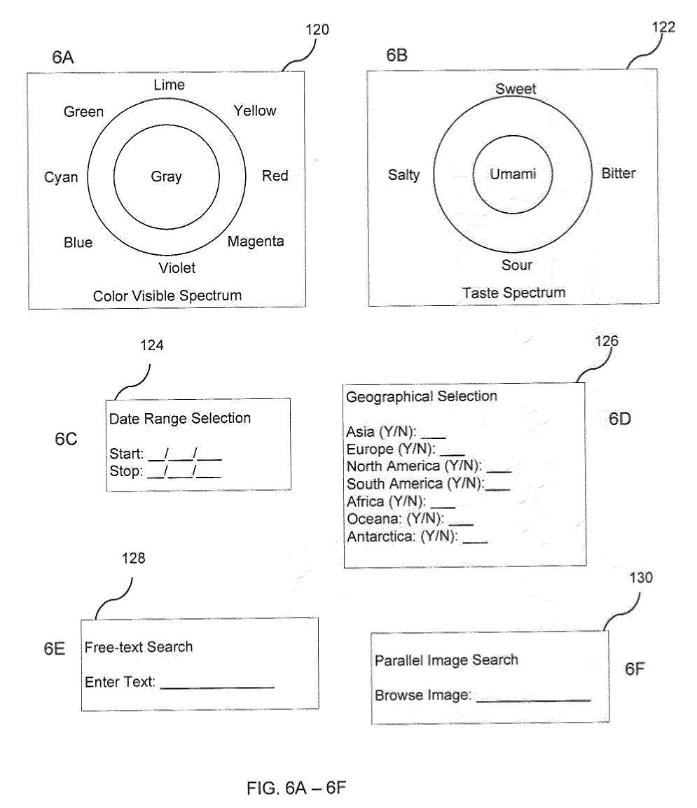

FIGS. 6A-6F depict a general overview of an advanced search processes and corresponding logic in which accessible captured data may be searched in an advanced manner in order to retrieve a specific set of captured data. FIG. 6A depicts color Visible spectrum data 120 said that allows an end user 10 to select one or more colors or a range of colors in order to narrow the field of captured data. FIG. 6B allows the end user 10 to further use taste spectrum data 122 to search captured data objects. FIG. 6C allows searching via data range selection 124. FIG. 6D allows the end user to use geographical selection 126 in order to further narrow a data search query. FIG. 6E depicts a free-text search 128. FIG. 6F allows for a parallel image search 130. The searches can be performed in succession, in an order determined by the end user, using all or some of the search parameters, or separately. Then, searched data is profiled and displayed in editable format in the editor and display module, thereby completing the searching process. The searching process would allow said end user 10 to search and locate a specific data input that would fit a respective criteria. For example, the system, method, and apparatus are configured such that one scientist is able to record their inputs via one, two or more input devices. The project topic could be a conversation between the scientist and another in a lab in Geneva in February of 2008 regarding a cluster of cells/that turned a specific color, developed a bitter taste, and that changed size to match the shape of a previously collected image. The system, method and apparatus will enable such data;input, so that a different authorized end user to search and locate the data input.

To retrieve or search data based on a visual query, the user may utilize a plurality and combination of criteria for the data objects, including but not limited to shape, color, motion, texture, and extraction and segmentation of features. To accelerate or facilitate the image search, the user may combine several criteria, including but not limited to visual characteristics, keywords, geo-location, time factors which could include recently captured visual data, and data which have been stored and time-stamped, as well as spatial factors pertaining to geo-referencing and geo-tagging. A visual data search algorithm would include a process based on the most recently captured data objects, the location at point-of-capture, keywords, and queries which would provide input for shape, color, texture, and motion for video-based images.

In another embodiment of the present invention, visual queries could combine behavioral or personal search (based on data most commonly searched by the user), automatic segmentation or sectional display of said images. Moreover, a user could upload an image and visual object and request or query a similar match based on characteristics, including but not limited to shape, color, texture, or motion, or a combination hereinabove. For example, if a user typed in “Taurus” in a traditional search engine keyword query, there would appear a variety of “Taurus” matches, based on that search engine's method and technology such as: an automobile, horoscope, a bull, and maybe even the name of town, restaurant or hotel. One of the embodiments of the present invention provides a more targeted visual search, either by selecting a similar image, pasting in a similar image, or selecting options from a menu module or digital palette that comprises a plurality of characteristics including but not limited to color, shape, texture, and size. By utilizing these visual characteristics, as well as combing keywords, in this search, the user will facilitate the retrieval of visual queries. For example, the user can search for and extract sections of collected data objects at the point of capture and utilizes these extracted data objects to locate similar or matching data objects. Alternatively, the end user can make visual search queries based on color, shape texture, or motion singularly, or in combination these factors and with geo-location, prior searches, and relevant keywords, as well as use of behavioral and personal searching.

As a further embodiment of the present invention, search methods for retrieving captured data objects include a plurality of sensory-based queries, including but not limited to touch, smell, sound, and even taste. For example, a user could utilize or click on the “taste” search button with keywords such as sugary, acidic or saline singularly, or in combination with other query modules like a “smell” search button with keywords such as ammonia, pungent, or fruity, or audio or voice search button with either sample sounds to locate parallel sounds or verbiage or keywords for audio or voice search such as “lab in Geneva”, “liver transplant patient,” or “PETSGAN, Miami,” to enhance a more targeted search for a data object or series of such.

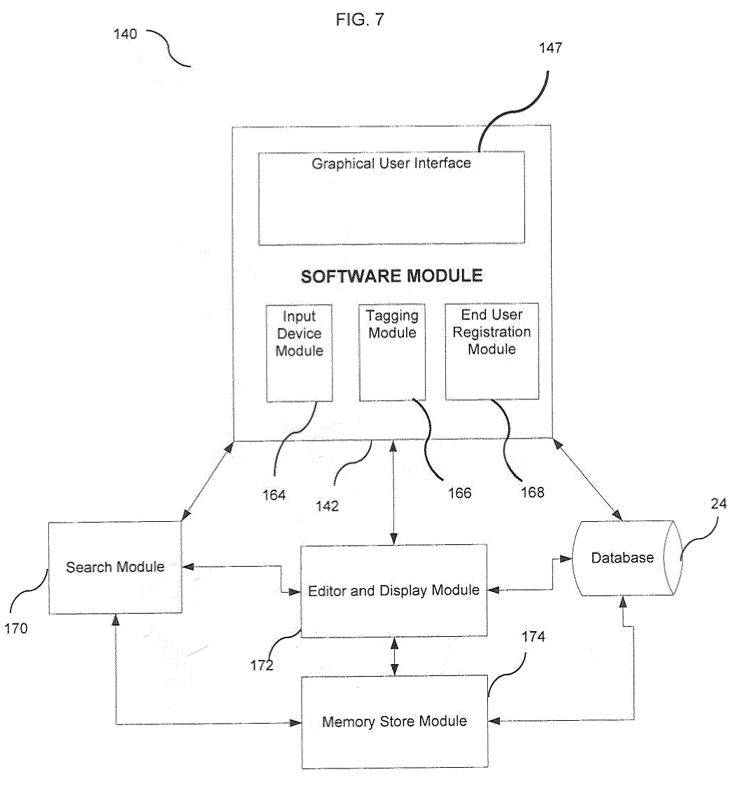

FIG. 7 depicts a general overview of the system of the invention 140 comprises a software module 142 that is operably connected to a search module 170, an editor and display module 172, and a database 24. The search module 170, the editor and display module 172, and the database 24 are all operably connected to each other. There may be a memory storage module 174, which is also operably connected to the search module 170, the editor and display module 172, and the database 24. The database 24 may consist of one or more databases, as can the memory storage module 174. The database(s) 24 and the memory storage module(s) 174 may be placed locally on the end users hardware or may be placed in a remote location.

The software module 142 can comprise an input device module 164, which allows the end user to input data objects into the system. The software module 142 can also comprise a tagging code, or module 166, which allows for automatic tagging of captured data objects or for the end user to directly tag the captured data objects. The software module 142 can further comprise an end user registration code, or module 168. This allows one or more end users to register in order to be able to use the software to capture, share, and edit data.

The one or more end users can view elements of the system through a graphical user interface 147. The graphical user interface can be in the form of a website, through a secure SSL channel, or HTTPS. The one or more end users can use one, two or more of several input devices to input data objects, into the system 140.

Both the memory storage module and the database can comprise one or more memory storage modules and databases. Further, these components may be located on a computer used by one of more end users, or may be located remotely from the end users.

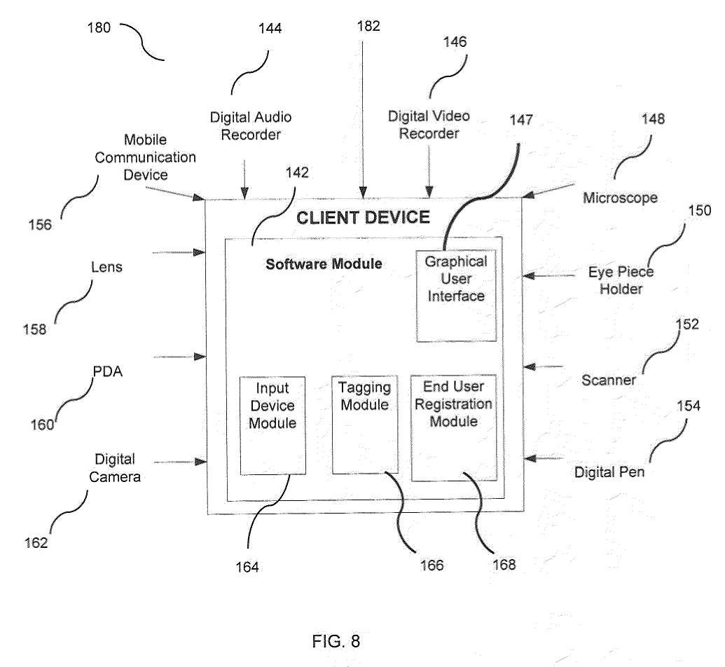

FIG. 8 depicts illustration of the apparatus of the invention 180 that comprises a client device 182 that may include, but is not limited to, a personal computer (PC), a tablet PC, a dumb terminal, net book, notebook or other similar device. Said client device 182 may also include standard and expected features such as an on-off switch, keyboard, battery, wireless and wire line connectors and a central processor unit. Said client device can display and/or store a software module 142 that is operably connected to the search module 170, an editor and display module 172, and a database 24, as seen in FIG. 7, and which are all operably connected as well.

There may be a memory storage module 174, which is also operably connected to the search module 170, the editor and display module 172, and the database 24. The database 24 may consist of one or more databases, as can the memory storage module 174. The database(s) 24 and the memory storage module(s) 174 may be placed locally on the client device 182 or may be placed in a remote location. The software module 142 can comprise an input device module 164, capable of interfacing with a plurality of different data input devices in a manner which allows the end user to input data objects into the client device 182. The software module 142 can also comprise tagging;code 166, which allows for automatic tagging, of captured data objects or for direct tagging of the captured data objects by an end user. The software module 142 can further comprise end user registration code 168. This allows one or more end users to register in order to be able to use the client device 182 to capture, share, and edit data.

Returning to FIG. 8, the one or more end users can view elements from the client device 182 through a graphical user interface 147. The graphical user interface can be in the form of a website, through a secure SSL channel, or HTTPS. The one or more end users can use one of several input devices to input data objects into the client device 182. The input devices can be, but are not limited to, a digital camera 162 a personal digital assistant (PDA) 160, a lens for image capture 158, a mobile communications device 156, a digital audio recorder 144, a digital video recorder 146, a microscope 148, an eye piece holder 150, a scanner 152, or a digital pen 154. All of said input devices may be either embedded into the form of the client device 182, or may be peripheral and separate hardware devices that may connect to said client device 182 by wireless or wired connectivity methods or a combination thereof.

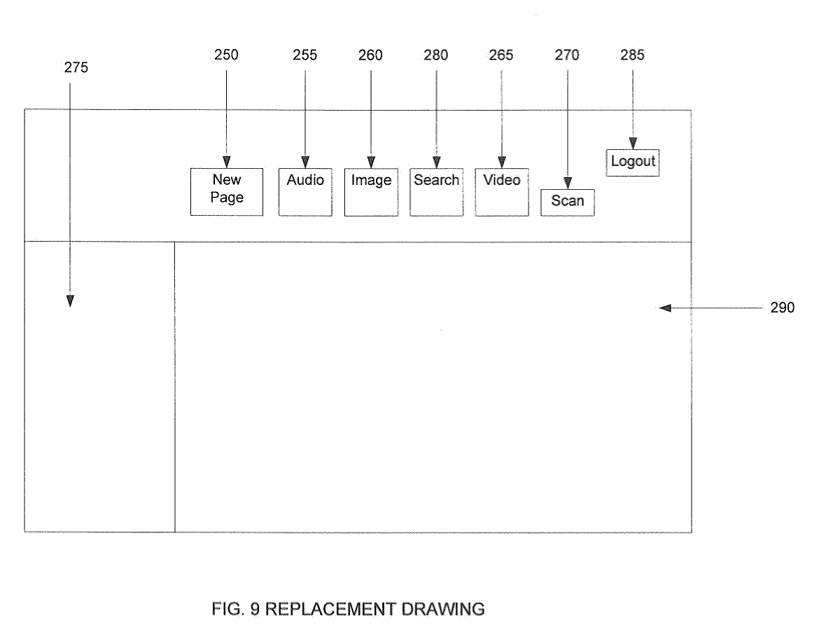

FIG. 9 depicts a sample editor and display screen. There, editor and display screen has buttons whereby an end user can begin a new page, 250, to enter audio 255, image 260, video 265, and scanner input 270 using the input devices as described. Further, this screen also enables maintenance of workflow for a project in a project workflow area 275, searching the stored captured data objects 280, and means to log but after the end user completes the desired work 285. Finally, screen 290 is the area in which an end user 10 can view, manipulate, and edit captured data objects.

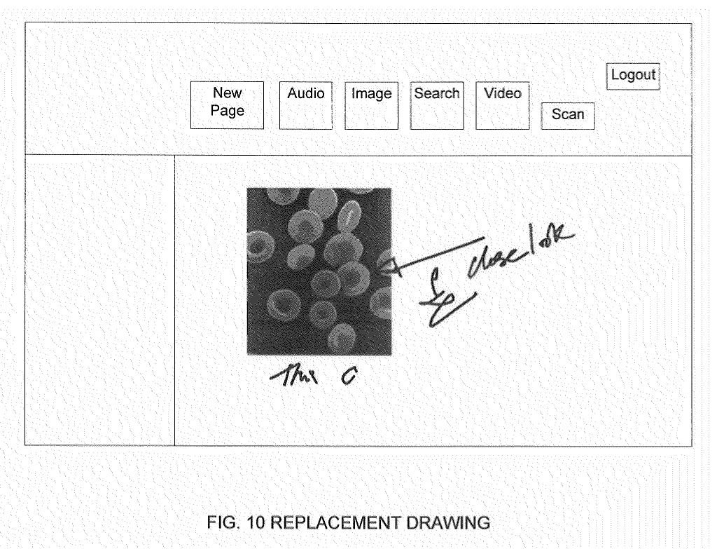

FIG. 10 depicts a sample project page which has received input in the form of a digital image from a digital camera, as well as end user notes, which were input using a digital pen. This figure shows that more than one input device can be utilized for the same data object input.

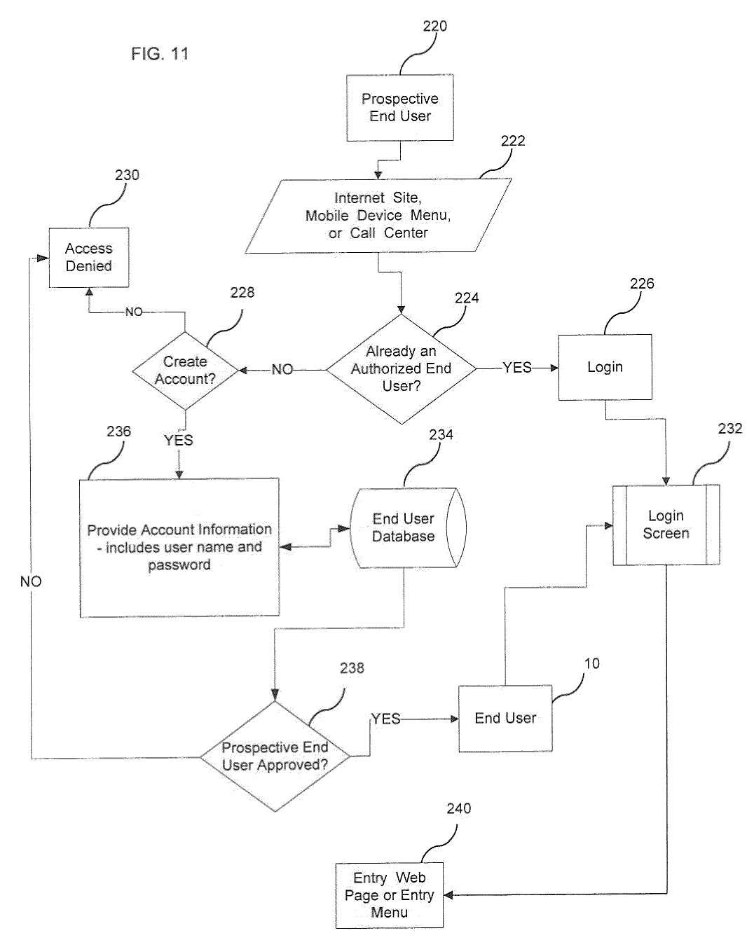

FIG. 11 depicts the end user registration process where a prospective end user 220 enters an Internet site, mobile device menu, or call center 222. If said prospective end user 220 is not already an authorized end user 224 then said prospective end user 220 may decide to create an account 228. If an account is not successfully created access will be denied 230. If the prospective end user 220 is already authorized they will arrive at a login screen 226. A prospective end user 220 that is not an authorized end user may decide to create an account 228, and if so, must provide account information including a user name and password 236, after which said account information will be analyzed for access parameters and prospective approval using information from an end user database 234. If said prospective end user is approved 238 then they become an end user 10. If said prospective end user is not approved 238 then access is denied 230. Said end user 10 may access a login screen 232 and a subsequent entry page or entry menu 240.

To facilitate the verification of a user accessing confidential data and to prevent an unauthorized person or a machine accessing said data, a project leader or manager can set up a CAPTCHA™ component or feature that relates to said data and information and team content and contributions, such as clicking on an image, such as a blood cell, protein, or a brain scan, and rotating the; image in the correct position, or providing the correct response to a question in a drop-down menu, such as “in what organ are beta cells located?,” or “what is common disorder that the drug dilating treats?,” or simply confirming a textual phrase in a block, in combination with a password used by the team for a particular project. The user may also utilize voice and speech to answer questions and complete CAPTCHA™ to establish verification and gain authorization to access confidential data.

The present invention provides an audit trail and the ability to retrieve specific data through semantic search queries, for example, queries such as “transplanted islet cells,” or “genetic predisposition for Huntington's Disease,” or “scan for melanoma,” or by entering key words in a search query, or utilizing behavioral search which comprises personal data and recent prior searches of the user, audio and voice search which locates specific phrases and verbiage such as “pancreas transplant,” “conference in Singapore,” “meeting in San Diego about wireless medicine.” On can also use visual queries for searching, which can combine keyword search, geo-tagging, and image search based on color, shape, texture, motion, and extracting visual features in an data image object, based on a plurality of criteria, including but not limited to pixels, frames, color, shape, texture, pattern recognition or motion. In addition, the present invention facilitates validation and verification, real-time data transfer, and the ability to modify and annotate captured data objects.

The foregoing description and drawings merely explain and illustrate the invention and the invention is not limited thereto. While the specification in this invention is described in relation to certain implementation or embodiments, many details are set forth for the purpose of illustration. Thus, the foregoing merely illustrates the principles of the invention. For example, the invention may have other specific forms without departing from its spirit or essential characteristic. The described arrangements are illustrative and not restrictive. To those skilled in the art, the invention is susceptible to additional implementations or embodiments and certain of these details described in this application may be varied considerably without departing from the basic principles of the invention. It will thus be appreciated that those skilled in the art will be able to devise various arrangements, which, although not explicitly described or shown herein, embody the principles of the invention and, thus, are within its scope and spirit.

What is claimed is:

1. A method for capturing, securing, sharing, retrieving, and searching data comprising:
providing a software module comprising
a graphical user interface for displaying captured data objects on a display;
an input device module operably connected to two or more input devices to capture data objects;
code for tagging captured data objects;
code for registering an end user; and
an editor and display module;
receiving data objects from the two or more input devices;
capturing the data objects to the editor and display module;
tagging the captured data objects with information selected from the group consisting of text, micro-blogging, voice, geo-references, keywords or a combination thereof;
transmitting the captured data objects to a database for storage in a searchable form;
wherein the software module, the editor and display module, the database and the search module are all operably connected.

2. The method of claim 1, wherein the data input devices are selected from the group consisting of a personal digital assistant (PDA), a mobile communications device; a scanner, an audio recorder, a video recorder, ah eye-piece holder, a microscope eyepiece, a lens for image capture, a digital pen, a digital camera, and combinations thereof.

3. The method of claim 1, wherein the data objects are selected from the group consisting of written text, digital images, audio, video, digital files, and a combination thereof.

4. The method of claim 1, wherein the captured data objects are tagged automatically.

5. The method of claim 1, wherein the captured data objects are tagged by an end user.

6. The method of claim 1, wherein the data objects are captured during an event selected from the group consisting of laboratory experiments, taking patient histories, medical procedures, group meetings, creative writing, and professional or personal journal keeping.

7. The method of claim 1, further comprising storing the captured data objects in a memory storage module prior to storing the captured data in the database.

8. The method of claim 1, wherein the captured data objects can be searched and retrieved from the memory store or the database in a form selected from the group consisting of written text, digital images, audio, video, digital files, and a combination thereof.

9. The method of claim 8, wherein the captured data objects can be searched and retrieved using a tool selected from the group consisting of geo-location, semantic, personal search, behavioral search, and multi-sensory queries, and a combination thereof.

10. The method of claim 9, wherein the multi-sensory queries are selected from the group consisting of visual, aural, tactile, and smell queries.

11. The method of claim 1, further comprising registering end users by creating end user profiles via an end user registration module, wherein the end users can share, edit, or add captured data after a verification, confirmation, and authentication of the end users.

12. The method of claim 11, wherein the end users are verified, confirmed or authenticated by a tool selected from the group consisting of password encryption, digital signatures, biometrics, challenge-response test modules, answers to preselected questions, geo-referencing and voice prints.

13. The method of claim 1, wherein the captured data objects are edited by the end users via a tool selected from the group consisting of annotations, revisions, comments, reviews, and feedback pertaining the captured data.

14. The method of claim 1, wherein the captured data objects are viewed as indexing via text, images as thumbnails, a slideshow format, audio clips, and video clips.

15. A system for capturing and sharing data objects comprising:
a software module comprising
a graphical user interface for displaying captured data objects on a display;
an input device module operably connected to one or more input devices to capture data objects to an editor and display module; and
a module for tagging captured data objects with information selected from the group consisting of text, micro-blogging, voice, geo-references, keywords or a combination thereof;
an editor and display module for allowing editing and display of captured data objects on the graphical user interface;
a database for storing captured data objects; and
a search module for allowing end users to search and retrieve captured data objects using the tagging information;
wherein the software module, the editor and display module, the database and the search module are all operably connected.

16. The system of claim 15, further comprising a memory store operably connected to the software module, the editor and display module, and the database for temporary storage of captured data.

17. The system of claim 15, wherein the two or more data input devices are selected from the group consisting of a personal digital assistant (PDA), a mobile communications device, a scanner, an audio recorder, a video recorder, an eye-piece holder, a microscope eyepiece, a lens for image capture, a digital pen, and a digital camera.

18. The system of claim 15, wherein the captured data objects are selected from the group consisting of written text, digital images, audio, video, digital files, and a combination thereof.

19. The system of claim 15, wherein the captured data objects can be searched and retrieved from the memory store or the database in a form selected from the group consisting of written text, digital images, audio, video, digital files, and a combination thereof.

20. The system of claim 19, wherein the captured data objects can be searched and retrieved using a tool selected from the group consisting of geo-location, semantic, personal search, behavioral search, and multi-sensory queries, and a combination thereof.

21. The method of claim 20, wherein the multi-sensory queries are selected from the group consisting of visual, aural, tactile, and smell queries.

22. The system of claim 15, wherein the captured data objects can be shared between end users.

23. The system of claim 15, further comprising code enabling end users to edit the captured data objects, wherein the captured data can be edited via annotations, revisions, comments, reviews, and feedback pertaining to the captured data.

24. The system of claim 15, wherein the captured data objects can be viewed as indexing via text, images as thumbnails, a slideshow format, audio clips, and video clips.

25. The system of claim 15, further comprising a module for allowing registration of one or more end users and creation of one or more end user profiles.

26. An apparatus comprising:
a client device comprising:
a software module allowing the input and capture of data objects by an end user;
a search module for allowing an end user to search captured data objects; and
an editor and display module for allowing an end user to review and edit captured data objects; and
a database for storing captured data objects operably connected to the client device.

27. The apparatus of claim 26, further comprising one, or more input devices selected from the group consisting of a personal digital assistant (PDA), a mobile communications device, a scanner, an audio recorder, a video recorder, an eye-piece holder, a microscope eyepiece, a lens for image capture, a digital pen, a digital camera and a combination thereof.

28. The apparatus of claim 26 further comprising a memory storage module operably connected to the software module, the editor and display module, the storage module, and the database.

29. The apparatus of claim 26, wherein the software module comprises code for tagging the captured data objects.

30. The apparatus of claim 29, wherein tagging the captured data objects can be performed automatically or directly by the end user.

31. The apparatus of claim 26, wherein one or more other end users can search, edit, and display captured data objects.

32. The apparatus of claim 26, wherein the software module further comprises end user registration code.

33. The apparatus of claim 26, wherein the captured data objects can be viewed via a graphical user interface.
